(19) United States
(12) Patent Application Publication
(10) Pub. No.: US 2026/0223775 A1
(43) Pub. Date: Aug. 6, 2026

(54) Patch Cleanup

(71) Applicant: Autonomous Solutions, Inc., Mendon, UT (US)

(72) Inventor: Nate Bunderson, Mendon, UT (US)

(73) Assignee: Autonomous Solutions, Inc., Mendon, UT (US)

(21) Appl. No.: 19/409,010

(22) Filed: Dec. 4, 2025

Related U.S. Application Data
(60) Provisional application No. 63/752,112, filed on Jan. 31, 2025.

(51) Int. Cl. A01D 34/00; A01D 101/00; B25J 9/16

(52) U.S. Cl. CPC A01D 34/008; B25J 9/161; B25J 9/1666; A01D 2101/00

(57) ABSTRACT

Disclosed are autonomous work vehicles, systems, and methods for implementing a pattern on a surface of a work area according to a predetermined design, scheme, or plan. The method employed by the autonomous work vehicle may include generating a plurality of paths, generating a combined path by linking the plurality of paths, and instructing the autonomous work vehicle to follow the combined path while interacting with a surface of the work area to implement the pattern. The plurality of paths may include one or more external paths, one or more internal paths, a plurality of swath paths, and a plurality of connection paths that connect the one or more external paths, internal paths, and swath paths together. Generating the combined path may also include determining any untraced areas of the work area and tracing these areas with patch paths that may then be linked with the combined path.

### BACKGROUND

Vehicles and other machines are increasingly used to create patterns on surface structures. For example, a golf course may employ precision mowers, often in teams of operators, to implement a pattern on the turf of fairways or rough portions of the course. Despite this, human operators, through error, frequently and reliably deviate from pattern designs, while labor and machine costs continue as significant sources of expense.

### SUMMARY

Disclosed are autonomous work vehicles, systems, and methods configured for implementing a pattern on a surface of a work area within an operating environment. Patterns implemented via an autonomous work vehicle may be superior to those created under manual operation in that an autonomous work vehicle may be operated more precisely, over larger time periods, and frequently in the dark (i.e., without daylight), enabling patterns to be achieved at lower labor and material cost.

The autonomous work vehicle may comprise a steering control system for autonomously controlling a driving direction of the autonomous work vehicle and a speed control system for autonomously controlling a speed of the autonomous work vehicle. The autonomous work vehicle may additionally comprise an implement control system for autonomously controlling an implement connected to the autonomous work vehicle. The implement may be configured to modify a ground surface of the work area for implementing the pattern. The autonomous work vehicle may comprise one or more processors communicatively coupled with the steering control system and the speed control system, and may comprise one or more computer-readable media having stored thereon instructions for employing a method for implementing the pattern on the surface of the work area.

The method may comprise generating a plurality of paths that trace over the work area, generating a combined path from the plurality of paths, and instructing the steering control system and the speed control system to drive the autonomous work vehicle along the combined path through the work area. The plurality of paths may include one or more external paths that delimit an exterior of the work area, one or more internal paths that bound one or more interior obstacles of the work area, and/or a plurality of swath paths that cover at least a majority of the work area between the external path and/or the internal paths. The plurality of paths may further include a plurality of connection paths, wherein each connection path of the plurality of connection paths has a first end and a second end, and wherein at least one of the first and second ends of each connection path extends from an external path, an internal path, and/or an end of a swath path. The connection paths may be generated based on a minimum turning radius of the autonomous work vehicle.

Generating the combined path may comprise connecting the external path, the one or more internal paths, the plurality of swath paths, and/or the plurality of connection paths to produce the combined path. Generating the combined path may further comprise determining any remaining untraced areas of the work area that are not traced by the combined path, creating one or more patch paths based on the untraced areas, and combining the one or more patch paths with the combined path.

The method may include instructing the implement control system to adjust the implement to a first position when the autonomous work vehicle follows the external path, the one or more internal paths, the plurality of swath paths, and/or the one or more patch paths, and adjust the implement to a second position when the autonomous work vehicle follows a connection path that extends outside the work area.

Adjacent swath paths may be separated by a distance equal to or less than a width of an operating implement connected to the autonomous work vehicle, such that a swept area of each of the adjacent swath paths meet and/or overlap. At least a subset of adjacent swath paths of the plurality of swath paths may each follow a separate straight line. At least a subset of adjacent swath paths of the plurality of swath paths may trace a contour of the external path.

The interior obstacle may be surrounded by only one internal path or may be surrounded by two or more internal paths. At least one of the one or more internal paths traces a profile of the interior obstacle. The autonomous work vehicle may follow the external path after following all of the plurality of swath paths. The method may include instructing the steering control system and the speed control system to drive the autonomous work vehicle along a patch path before driving along all adjacent paths.

The autonomous work vehicle may comprise an autonomous mower, the implement may comprise a mower reel, and work area may comprise at least a portion of a golf course. The work area may be divided into a first section and a second section, and a height of the mower reel may adjusted based on over which section the autonomous mower is operating.

These illustrative embodiments are mentioned not to limit or define the disclosure, but to provide examples to aid understanding. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying Drawings. In the Drawings, like reference numerals may be utilized to designate corresponding or similar parts in the various Figures, and the various elements depicted are not necessarily drawn to scale, wherein:

FIG. 1 shows an illustrative computational system for performing functionality to facilitate implementation of embodiments described in this document.

FIG. 2 illustrates a block diagram of an example autonomous work vehicle communication system of the present disclosure.

FIG. 3 is a side view of an autonomous yard truck according to some embodiments.

FIG. 4 is a perspective view of an autonomous mower according to some embodiments.

FIG. 5 is a side view of an autonomous tractor according to some embodiments.

FIG. 6 shows a diagram of a golf course for implementing a pattern according to the disclosed embodiments.

FIG. 7 illustrates a diagram of a work area that includes an obstacle, with external paths tracing the work area near the outer limits and an internal path that traces the work area around the obstacle.

FIG. 8 illustrates a diagram of the work area with swath paths tracing the work area between the external and internal paths.

FIG. 9 shows a diagram of a baseball field wherein the swath paths follow a contour of the outfield wall.

FIG. 10 illustrates a diagram of the work area with connection paths linking the swath paths (e.g., with the external and/or internal paths) to form a combined path.

FIG. 11 shows a zoom view of the diagram of FIG. 10, illustrating the connection paths liking some of the swath paths to the internal path.

FIG. 12 illustrates a diagram of the work area overlaid with the combined path and the swept areas of the external and internal paths.

FIG. 13 shows a diagram of the work area overlaid with the combined path and the swept areas of the swath paths.

FIG. 14 shows a diagram of the work area overlaid with the combined path and the swept areas of the external, internal, and swath paths.

FIG. 15 illustrates a diagram of the work area, including swath paths that extending generally perpendicular to the swath paths of FIG. 8 and FIGS. 10-14.

FIG. 16 shows a diagram of the work area, including the swept areas of the swath paths of FIG. 15.

FIG. 17 illustrates a diagram of the work area overlaid with the combined path and the swept areas of the external, internal, and swath paths.

FIG. 18 illustrates a diagram of the work area similar to the diagram of FIG. 15, further illustrating patch paths that trace uncovered areas of FIG. 17.

FIG. 19 illustrates a diagram of the work area similar to the diagram of FIG. 15, further illustrating patch paths the trace additional uncovered areas.

### DETAILED DESCRIPTION

Vehicles and other machines are increasingly used to create patterns on surface structures. However, applying patterns at large scales (e.g., hundreds or thousands of feet, or greater) is often dauting and difficult, often requiring significant cooperation. For example, a golf course may employ precision mowers, often in teams of operators, to implement a pattern on the turf of fairways or rough portions of the course. Operators of equipment are often inefficient and prone to making errors, such as deviating from a path of the pattern design, which disturbs the pattern despite relatively large cost in labor and machinery.

Autonomous work vehicle systems are increasingly adapted to interface with and alter the surface of an operating environment. For example, autonomous work vehicles now include autonomous mowers, autonomous vacuum cleaners, and autonomous driving street sweepers. Autonomous work vehicles and other autonomous systems may be used to aesthetically transform an operating environment according to a desired pattern design and to implement patterns on the surface of the operating environment. For example, an autonomous mower may cut the turf of a golf course to form a particular, pleasing pattern. Such autonomous mowers, relying on global positioning system (GPS) and modern sensing technology (e.g., LiDAR) may be enabled to follow predetermined patterns with precision.

The pattern may be implemented when the autonomous work vehicle interfaces a surface of the work area of the operating environment with an implement while following a combined path. The combined path may be formed through a process of creating and linking several types of paths. The process may include forming external paths that trace an outer limit of the work area, internal paths that bound obstacles within the work area, and swath paths that extend between the external paths and/or the internal paths. Connection paths may then be created that extend between the ends of the external, internal, and swath paths. The combined path may then be formed by linking the connection paths with the external, internal and swath paths. Finally, patch paths that extend over any remaining uncovered areas may be created and linked with the above paths to form the final combined path. The autonomous work vehicle may then follow the path, interfacing with the ground surface of the work area to implement the pattern.

While the disclosure below is generally directed towards autonomous mowing, one skilled in the art would understand the disclosure may be useful in other contexts, such as forming carpet patterns using autonomous vacuum cleaning, forming the pattern of Zen dry garden using autonomous sweeping or raking equipment, or other applications of implementing patterns on ground surfaces at scale.

As used herein, the term “trace” may refer to the manner in which a line extends over a surface according to or following a predetermined design, scheme, or plan. Generated paths may trace over a representation of an area by following a curvature of an outer limit, object, or natural structure of the area, or by following a predetermined motif of a pattern.

As used herein, the term “motif” may refer to a repeating aspect of a pattern. The motif may refer to straight lines (as used in a striped or checkered pattern), angled lines, curved lines, or other motif that when repeated over or within a plurality of generated paths may form at least a portion of a desired pattern on a surface of the work area.

As used herein, the term “bound” may refer to the manner in which a feature extends over at least a portion of an exterior of an area or object. Generated paths may bound an area or object by extending along or around a limit or exterior of the area or object.

As used herein, the terms “swept” or “sweep” may refer to removal or alteration of at least a portion of a surface, such as by cutting a surface of an area, or redistributing material on a surface of an area. Where description is made to “cutting a surface of the work area” (such as a grassy surface) or its variants, one may substitute the term “transforming a surface of the work area” to refer to alteration by the autonomous work vehicle, for example, by brushing, drawing, raking, or other action. A “swept area” may refer to a portion of the work area having a surface that has or is planned to be altered by the autonomous work vehicle while traveling along a corresponding path.

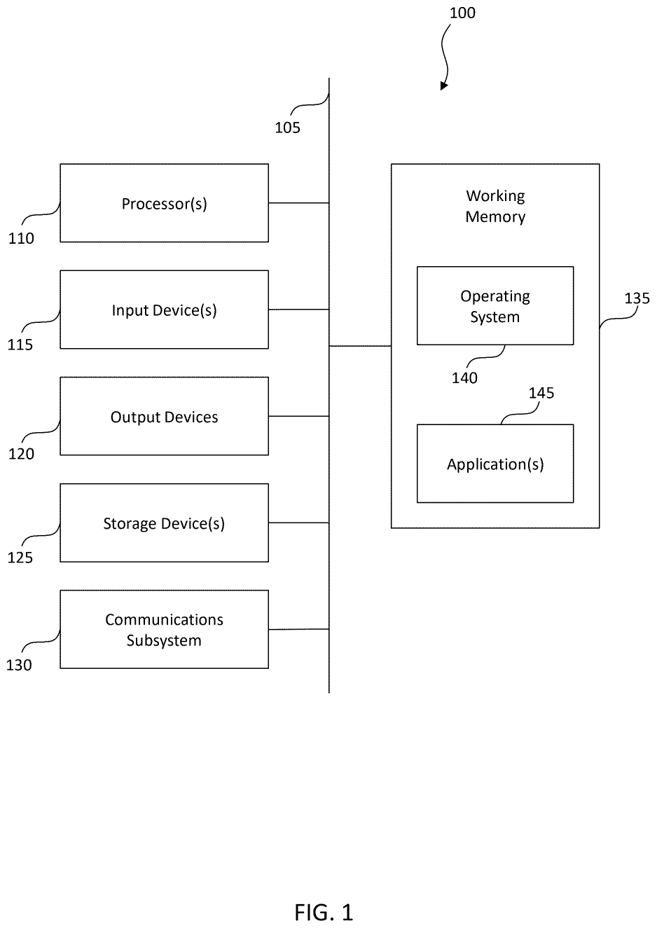

The computational system 100, shown in FIG. 1, can be used to perform any of the embodiments of the invention. As another example, computational system 100 can be used to perform any calculation, identification, and/or determination described here. Computational system 100 includes hardware elements that can be electrically coupled via a bus 105 (or may otherwise be in communication, as appropriate). The hardware elements can include one or more processors 110, including without limitation one or more general-purpose processors and/or one or more special-purpose processors (such as digital signal processing chips, graphics acceleration chips, and/or the like); one or more input devices 115, which can include without limitation a mouse, a keyboard, and/or the like; and one or more output devices 120, which can include without limitation a display device, a printer, and/or the like.

The computational system 100 may further include (and/or be in communication with) one or more storage devices 125, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable, and/or the like. The computational system 100 might also include a communications subsystem 130, which can include without limitation a modem, a network card (wireless or wired), an infrared communication device, a wireless communication device and/or chipset (such as a Bluetooth device, an 802.6 device, a Wi-Fi device, a WiMax device, cellular communication facilities, etc.), and/or the like. The communications subsystem 130 may permit data to be exchanged with a network (such as the network described below, to name one example), and/or any other devices described herein. In many embodiments, the computational system 100 will further include a working memory 135, which can include a RAM or ROM device, as described above.

The computational system 100 also can include software elements, shown as being currently located within the working memory 135, including an operating system 140 and/or other code, such as one or more application programs 145, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 125 described above.

In some cases, the storage medium might be incorporated within the computational system 100 or in communication with the computational system 100. In other embodiments, the storage medium might be separate from a computational system 100 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 100 and/or might take the form of source and/or installable code, which, upon compilation and/or installation on the computational system 100 (e.g., using any of a variety of generally available compilers, installation programs, compression/decompression utilities, etc.) then takes the form of executable code.

The computational system 100 may be configured to operate an autonomous work vehicle platform. The term “autonomous work vehicle”, and related terms (e.g., “autonomous work vehicle platform”), as used herein may include manned vehicles, remote control vehicles, and/or manual vehicles, etc. The autonomous work vehicle platform may comprise a steering mechanism in communication with the processor, where the processor communicates steering commands to the steering mechanism based on the combined path. The autonomous work vehicle platform may comprise a braking mechanism in communication with the processor, where the processor communicates braking commands to the braking mechanism based on the combined path.

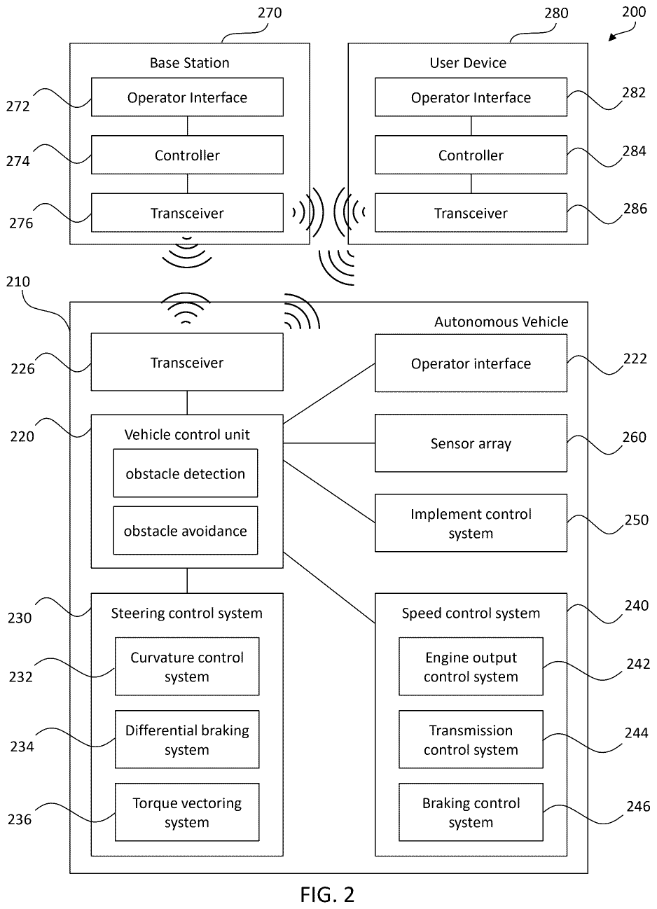

FIG. 2 is a block diagram of a communication and control system 200 that may be utilized in conjunction with the systems and methods of the disclosure. The communication and control system 200 may include a vehicle control unit 220 which may be mounted on an autonomous work vehicle 210. The autonomous work vehicle 210, for example, may include a yard truck, loader, wheel loader, track loader, dump truck, digger, backhoe, forklift, mower (e.g., lawn, field, or brush mower), or other vehicle. The communication and control system 200, for example, may include any or all components of computational system 100 shown in FIG. 1.

For example, the autonomous work vehicle 210 may include a steering control system 230 that may control a direction of movement of the autonomous work vehicle 210. The steering control system 230, for example, may include any or all components of computational system 100 shown in FIG. 1.

The autonomous work vehicle 210, for example, may include a speed control system 240 that controls the speed, acceleration, and deceleration of the autonomous work vehicle 210. The speed control system 240, for example, may control the speed of the autonomous work vehicle 210 based on map data, control algorithms, obstacle detection, start and/or stop points, input from the operator (e.g., a remote operator), etc. The speed control system 240, for example, may include any or all components of computational system 100 shown in FIG. 1.

The autonomous work vehicle 210, for example, may include an implement control system 250 that may control operation of an implement towed by the autonomous work vehicle 210, integrated within the autonomous work vehicle 210, or coupled to the autonomous work vehicle 210. The implement control system 250, for example, may include any type of implement such as, for example, a bucket, a shovel, a blade, a thumb, a dump bed, a plow, an auger, a trencher, a scraper, a broom, a hammer, a grapple, forks, boom, spears, a cutter, a wrist, a tiller, a rake, etc. The implement control system 250, for example, may include any or all components of computational system 100 shown in FIG. 1.

The vehicle control unit 220 may be communicatively coupled with the steering control system 230, the speed control system 240, and/or the implement control system 250. The vehicle control unit 220, for example, may include any or all of the components shown in FIG. 1. The vehicle control unit 220, for example, may be integrated into a single controller or may include a plurality of distinct components or controllers. The vehicle control unit 220 may also be coupled with one or more sensors from the sensor array 260 and receive sensor data from the sensor array 260.

The vehicle control unit 220, for example, may be used to control various aspects of the vehicle 210 such as, for example, sending instructions to the steering control system 230, implement control system 250, speed control system 240, etc. The vehicle control unit 220, for example, may include a vehicle artificial intelligence (VAI) that may include one or more processors that execute one or more algorithms.

The vehicle control unit 220, for example, may receive signals relative to many parameters of interest including, but not limited to: vehicle position, vehicle speed, vehicle heading, desired path location, off-path normal error, desired off-path normal error, heading error, vehicle state vector information, curvature state vector information, turning radius limits, steering angle, steering angle limits, steering rate limits, curvature, curvature rate, rate of curvature limits, roll, pitch, rotational rates, acceleration, and the like, or any combination thereof. These signals, for example, may come from the sensor array 260 or from a base station 270 (described below).

The vehicle control unit 220, for example, may be an electronic controller with electrical circuitry configured to process data from the various components of the autonomous work vehicle 210. The vehicle control unit 220 may include a processor, such as the processor 110, and a working memory 135. The vehicle control unit 220 may also include one or more storage devices, storage media, and/or other suitable components of computational system 100. The processor may be used to execute software, such as software for calculating drivable path plans. Moreover, the processor may include multiple microprocessors, one or more “general-purpose” microprocessors, one or more special-purpose microprocessors, and/or one or more application specific integrated circuits (ASICS), or any combination thereof. For example, the processor may include one or more reduced instruction set (RISC) processors. The vehicle control unit 220, for example, may include any or all the components shown in FIG. 1.

The vehicle control unit 220, for example, may include a volatile memory, such as random access memory (RAM), and/or a nonvolatile memory, such as ROM (e.g., working memory 135, storage device 125, and/or other computer-readable media). The memory may store a variety of information and may be used for various purposes. For example, the memory may store processor-executable instructions (e.g., firmware or software) for the vehicle control unit 220 to execute, such as instructions for calculating a drivable path plan, and/or controlling the autonomous work vehicle 210. The memory may include flash memory, one or more hard drives, or any other suitable optical, magnetic, or solid-state storage medium, or a combination thereof. The memory may store data such as field maps, maps of desired paths, vehicle characteristics, software or firmware instructions, and/or any other suitable data.

The steering control system 230, for example, may include a curvature rate control system 232, a differential braking system 234, a steering mechanism, and a torque vectoring system 236 that may be used to steer the autonomous work vehicle 210. The curvature rate control system 232, for example, may control a direction of an autonomous work vehicle 210 by controlling a steering control system of the autonomous work vehicle 210 with a curvature rate, such as an Ackerman style autonomous work vehicle, 210 or articulating vehicle. The curvature rate control system 232, for example, may automatically rotate one or more wheels or tracks of the autonomous work vehicle 210 via hydraulic or electric actuators to steer the autonomous work vehicle 210. By way of example, the curvature rate control system 232 may rotate front wheels/tracks, rear wheels/tracks, and/or intermediate wheels/tracks of the autonomous work vehicle 210 or articulate the frame of the vehicle, either individually or in groups. The differential braking system 234 may independently vary the braking force on each lateral side of the autonomous work vehicle 210 to direct the autonomous work vehicle 210. Similarly, the torque vectoring system 236 may differentially apply torque from the engine to the wheels and/or tracks on each lateral side of the autonomous work vehicle 210. While the illustrated steering control system 230 includes the curvature rate control system 232, the differential braking system 234, and the torque vectoring system 236, the steering control system 230 may include one or more of these systems. Further examples may include a steering control system 230 having other and/or additional systems to facilitate turning the autonomous work vehicle 210 such as an articulated steering control system, a differential drive system, and the like.

The speed control system 240, for example, may include an engine output control system 242, a transmission control system 244, and a braking control system 246. The engine output control system 242 may vary the output of the engine to control the speed of the autonomous work vehicle 210. For example, the engine output control system 242 may vary a throttle setting of the engine, a fuel/air mixture of the engine, a timing of the engine, and/or other suitable engine parameters to control engine output. In addition, the transmission control system 244 may adjust gear selection within a transmission to control the speed of the autonomous work vehicle 210. Furthermore, the braking control system 246 may adjust the braking force to control the speed of the autonomous work vehicle 210. While the illustrated speed control system 240 includes the engine output control system 242, the transmission control system 244, and the braking control system 246, the speed control system 240 may include one or two of these systems. The speed control system 240, for example, may also include other systems and/or additional systems that may be used to control the speed of the autonomous work vehicle 210.

The implement control system 250, for example, may control various parameters of the implement towed by and/or integrated within the autonomous work vehicle 210. For example, the implement control system 250 may instruct an implement controller via a communication link, such as a CAN bus, ISOBUS, Ethernet, wireless communications, and/or Broad R Reach type Automotive Ethernet, etc.

The implement control system 250, for example, may instruct an implement controller to adjust a penetration depth of at least one ground engaging tool of an agricultural implement, which may reduce the draft load on the autonomous work vehicle 210.

The implement control system 250, as another example, may instruct the implement controller to transition an agricultural implement between a working position and a transport portion, to adjust a flow rate of product from the agricultural implement, to adjust a position of a header of the agricultural implement (e.g., a harvester, etc.), among other operations, etc. The implement control system 250, as another example, may instruct the implement controller to adjust a shovel height, a shovel angle, a shovel position, etc.

The communication and control system 200, for example, may include a sensor array 260. The sensor array 260, for example, may facilitate determination of condition(s) of the autonomous work vehicle 210 and/or the work area. For example, the sensor array 260 may include one or more sensors (e.g., infrared sensors, ultrasonic sensors, magnetic sensors, tachometer, radar sensors, LiDAR sensors, terahertz sensors, sonar sensors, wheel encoders, cameras, etc.) that monitor a rotation rate of a respective wheel and/or track a ground speed of the autonomous work vehicle 210. The sensors may also monitor operating levels (e.g., temperature, fuel level, etc.) of the autonomous work vehicle 210. Furthermore, the sensors may monitor conditions in and around the work area, such as temperature, weather, wind speed, compass, humidity, and other conditions. The sensors of the sensor array 260, for example, may detect physical objects in the work area, such as a parking stall, a material stall, accessories, other vehicles, obstacles, environmental features, or other object(s) that may be in the area surrounding the autonomous work vehicle 210.

The sensor array 260, for example, may include a velocity sensor which may include one or more of an inertial measurement unit, a compass, a GPS sensor, a wheel encoder, a tachometer, a camera, a radar, etc. The sensor array 260, for example, may also include a steering angle sensor. The velocity sensor, for example, may produce velocity data. Velocity data may include information regarding speed and/or bearing. Velocity data, for example, may additionally, or alternatively, include information regarding the steering angular rate.

The autonomous work vehicle 210 may include an operator interface 222 for controlling the vehicle. The operator interface 222, for example, may be communicatively coupled to the vehicle control unit 220 and configured to present data from the autonomous work vehicle 210 via a display. Display data may include data associated with operation of the autonomous work vehicle 210, data associated with operation of an implement, a position of the autonomous work vehicle 210, a speed of the autonomous work vehicle 210, a desired path, a drivable path plan, a target position, and/or a current position, etc. The operator interface 222 may enable an operator to control certain functions of the autonomous work vehicle 210 such as starting and stopping the autonomous work vehicle 210, inputting a desired path, etc. The operator interface 222, for example, may enable the operator to input parameters that cause the vehicle control unit 220 to adjust the drivable path plan. For example, the operator may provide an input requesting that the desired path be acquired as quickly as possible, that an off-path normal error be minimized, that a speed of the autonomous work vehicle 210 remain within certain limits, and/or that a lateral acceleration experienced by the autonomous work vehicle 210 remain within certain limits, etc. In addition, the operator interface 222 (e.g., via the display, or via an audio system (not shown), etc.) may alert an operator if the desired path cannot be achieved, for example.

The communication and control system 200, for example, may include a base station 270 having a base station controller 274 located remotely from the autonomous work vehicle 210. For example, the control functions of the vehicle control unit 220 may be distributed between the vehicle control unit 220 of the autonomous work vehicle 210 and the base station controller 274. The base station controller 274, for example, may perform a substantial portion of the control functions of the vehicle control unit 220. For example, a first transceiver 226 positioned on the autonomous work vehicle 210 may output signals indicative of vehicle characteristics (e.g., position, speed, heading, curvature rate, curvature rate limits, maximum turning rate, minimum turning radius, steering angle, roll, pitch, rotational rates, acceleration, etc.) to a second transceiver 276 at the base station 270. The base station controller 274, for example, may calculate drivable path plans and/or output control signals to control the curvature control system 232, the speed control system 240, and/or the implement control system 250 to direct the autonomous work vehicle 210 toward the desired path, for example. The base station controller 274 may include a processor and memory device having similar features and/or capabilities as the processor and the memory device discussed previously. Likewise, the base station 270 may include an operator interface 272 having a display, which may have similar features and/or capabilities as the operator interface 222 and the display discussed previously.

In some embodiments, one or both of the base station 270 and/or the autonomous work vehicle 210 may be in communication with a user device 280. A user device 280 may include a phone, tablet, laptop, or computer. The user device 280 may similarly include an operator interface 282 which may include similar features and capabilities as operator interfaces 222, 272 described above. Additionally, or alternatively, the user device 280 may comprise a controller 284 that may include the same or similar features, components, and/or characteristics as the controller 274 of the base station 270. For example, the user device controller 274 may calculate drivable path plans, output control signals to control the curvature control system 232, the speed control system 240, and/or the implement control system 250 to direct the autonomous work vehicle 210. The user device 280, for example, can include an application that allows the user (e.g., a remote operator) to communicate commands to the autonomous work vehicle 210 (e.g., via a transceiver 286) and/or receive information about the autonomous work vehicle 210. Alternatively, or additionally, the user device 280, for example, can include an application that allows the operator to observe the autonomous work vehicle 210 move through a map of the work area where the autonomous work vehicle operates.

The user device 280, for example, may include an application that can receive an indication associated with the remote operator or which can receive other user or operator inputs. The user device 280, for example, may include an application that can display any of the information disclosed in this document.

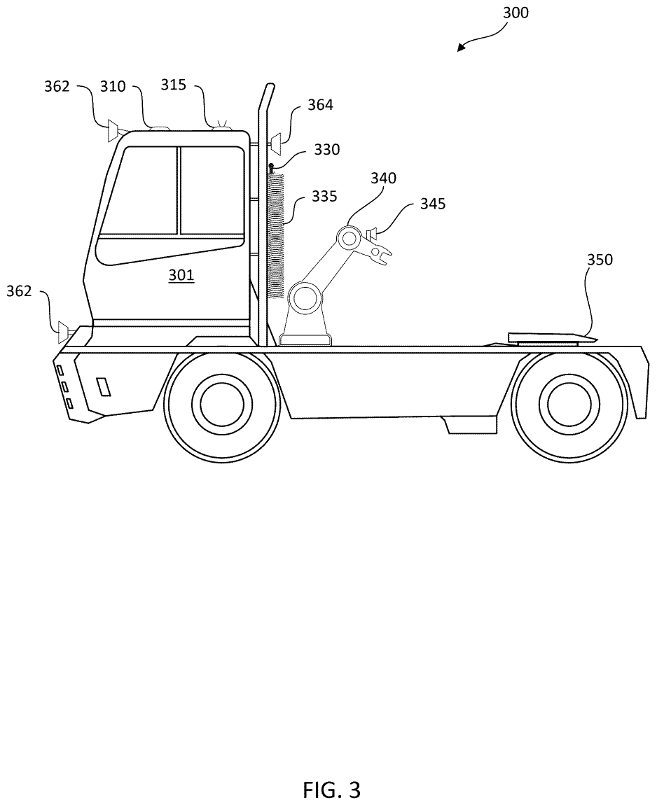

FIG. 3 is a side view of an autonomous yard truck 300 according to some embodiments. The autonomous yard truck 300 includes a cab 301 that may be used to drive the autonomous yard truck 300 manually. The autonomous yard truck 300 may include one or more of the components shown in FIG. 2. The autonomous yard truck 300 may also include a brake system, an engine, a transmission, steering, sensor array, etc. such as, for example, as shown in FIG. 2.

In some embodiments, the autonomous yard truck 300 may include a sensor array that includes sensors 362 (e.g., sensor array 260) disposed at various locations on the autonomous yard truck 300 such as, for example, on the cab 301, bumper, housing, frame, etc. The sensors 362 may include infrared sensors, ultrasonic sensors, magnetic sensors, radar sensors, LiDAR sensors, terahertz sensors, sonar sensors, cameras, etc. The sensor array of the autonomous yard truck 300 may also include one or more backup sensors 364 such as, for example, infrared sensors, ultrasonic sensors, magnetic sensors, radar sensors, LiDAR sensors, terahertz sensors, sonar sensors, cameras, etc.

In some embodiments, the autonomous yard truck 300 may include a spatial locating device (or GPS) antenna 310. In some embodiments, the autonomous yard truck 300 may include a transceiver antenna 315.

In some embodiments, the autonomous yard truck 300 may include one or more hoses 335 that can connect with a trailer such as, for example, two or three hoses. Each hose may have a hose connector 330 that can connect with a trailer hose connector. For example, the one or more hoses 335 of the autonomous yard truck 300 may include a service brake hose, an emergency brake hose, and/or a refrigerant hose.

In some embodiments, the autonomous yard truck 300 may include a robotic arm 340 disposed on the back bed of the autonomous yard truck 300. The robotic arm 340 may include any type of robotic arm. The robotic arm 340, for example, may exert high torque or high pressure sufficient to connect the hose connector 330 with the trailer hose connector. The hose connector 330 and/or the trailer hose connector may comprise a glad-hand connector. In some embodiments, when the autonomous yard truck 300 is not coupled with a trailer, the hose connector 330 may be positioned in a storage rack at some point on the autonomous yard truck 300 such as, for example, on the rear of the cab 301.

In some embodiments, the robotic arm 340 may include one or more arm sensors 345 such as, for example, infrared sensors, ultrasonic sensors, magnetic sensors, radar sensors, LiDAR sensors, terahertz sensors, sonar sensors, cameras, etc. The arm sensor 345, for example, may produce data that can be used to identify the location of a hose connector 330 and/or a trailer hose connector. The arm sensor 345, for example, may produce data that can show that a hose connector 330 and/or a trailer hose connector are sufficiently coupled.

In some embodiments, the autonomous yard truck 300 may include a fifth-wheel coupling 350. The fifth-wheel coupling 350, for example, may be raised or lowered with a fifth-wheel coupling boom. FIG. 3 shows the fifth-wheel coupling 350 in a lowered position. The fifth-wheel coupling 350 may couple with a kingpin of a trailer.

When the fifth-wheel coupling 350 is coupled with a kingpin and the fifth-wheel coupling 350 is in the raised position, the legs of the trailer may lift off the ground (e.g., automatically). This may allow the autonomous yard truck 300 to pull the trailer without individually raising the trailer legs.

In some embodiments, the robotic arm 340 and/or the arm sensor 345 may be coupled with a thermal management system. A thermal management system may, for example, be coupled with a thermal management system associated with the autonomous yard truck 300 such as, for example, coupled with the cab heating/cooling system and/or the engine heating/cooling system. A thermal management system may, for example, be an independent system that heats and/or cools the robotic arm 340 and/or the arm sensor 345. A thermal management system may, for example, keep the temperature of the robotic arm 340 and/or the arm sensor 345 between about 32° F. and about 100° F.

In some embodiments, the autonomous yard truck 300 may include a deployable shade coupled with the back of the cab 301. The deployable shade, for example, may be used to screen the sun and/or other lighting from the arm sensor 345 and/or the one or more backup sensors 364. The deployable shade, for example, may include an umbrella configuration or an awning configuration. The deployable shade, for example, may be coupled with the roof or an upper portion of the cab.

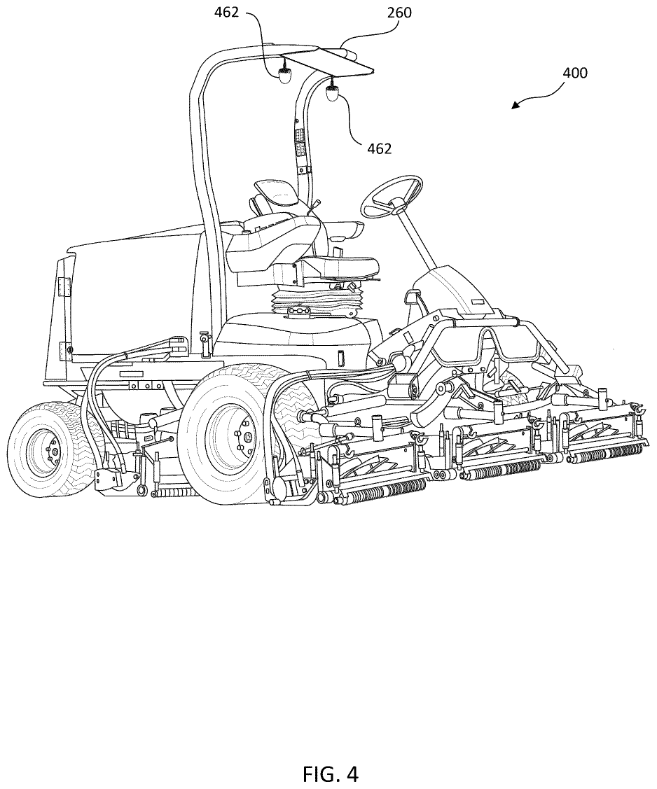

FIG. 4 is a sideview of an example autonomous mower 400, which may include all or some of the components of autonomous work vehicle 210. The autonomous work vehicle in this document may include the autonomous mower 400. Any type of mower or blades may be used, such as a disc mower. The autonomous mower 400, for example, may include a sensor array 260 (or multiple sensor arrays 260), including sensors 462. The sensor array 260 may include, for example, one or more LiDAR, radar, and/or video cameras. The video cameras, for example, may include 360 degree cameras, a front facing camera, and/or a back facing camera.

FIG. 5 is a sideview of an example autonomous tractor 500, which may include all or some of the components of autonomous work vehicle 210. The autonomous work vehicle in this document may include the autonomous tractor 500. In this example, the autonomous tractor 500 may include standard tractor equipment and/or components. The autonomous tractor 500 may include or be coupled with any kind of implement such as, for example, a plow, disc plow, reel mower, dumper, lift, bucket, shovel, blade, and/or cutter, etc. The autonomous tractor 500, for example, may include a sensor array 260 (or multiple sensor arrays 260), including sensor(s) 562. The sensor array 260 may include, for example, one or more LiDAR, radar, and/or video cameras. The video cameras, for example, may include 360 degree cameras, a front facing camera, and/or a back facing camera.

A combined path may be generated for an autonomous work vehicle to follow for implementing a pattern on a surface of a work area within an operating environment. The following description will be generally directed to implementing a pattern on a grassy surface, such as a lawn or turf, by an autonomous work vehicle comprising an autonomous mower. The autonomous mower may comprise a mower reel that cuts the grassy surface. In some embodiments, a height of the mower reel may be adjustable. However, other autonomous work vehicles or machines may employ this disclosure to implement similar patterns, particularly on surfaces of work areas that change over time, such as growing surfaces comprising plant or other life, open-air surfaces prone to disturbance from wind or other atmospheric conditions, or other surfaces prone to disturbance by people or animals (e.g., carpet).

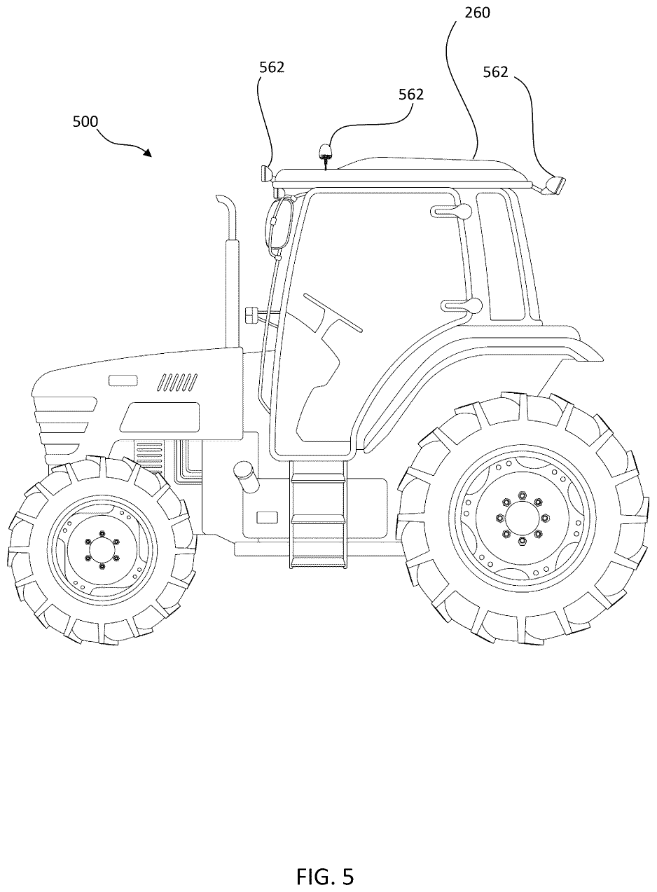

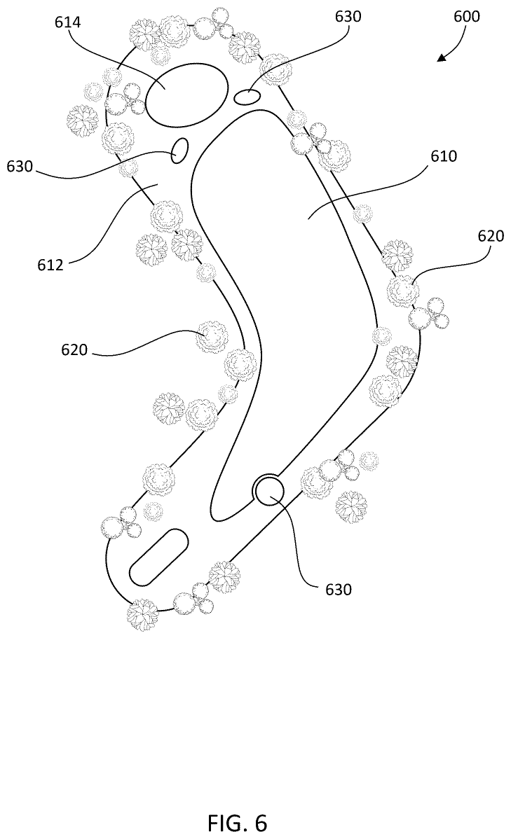

FIG. 6 illustrates an operating environment for an autonomous mower that comprises a golf course 600. Typically, to implement patterns on such a golf course 600, multiple mowers may be employed simultaneously, often operating in formation to cut the surface of the work area and form a pattern, such as a pattern of a striped or checkered surface. Multiple mowers are employed so as to reduce the time required to cut the surface. Daylight is typically required to safely operate these mowers, which may be operated in the early morning before the golf course 600 opens to the public. Multiple mowers operate together to both save time and ensure consistency in the implemented pattern. This represents increased cost in machinery and labor hours to the operation of the golf course 600. Despite this, human operators continue to make mistakes resulting in imperfections of the implemented pattern. These mistakes may include deviating from a desired pattern from insufficient concentration or carelessness or difficulty approximating a desired straight or curved line, often over undulating terrain.

Autonomous mowers have several advantages over manually-operated vehicles. The autonomous mower does not require daylight to operate (e.g., relying on GPS, LiDAR, infra-red, or other sensing techniques), increasing the available time to operate the autonomous mower between the closing and the opening of the golf course 600. This may enable an autonomous mower on its own to implement the pattern on the surface of the golf course 600 without the assistance of other mowing machinery and without the direct supervision of human operators, resulting in decreased costs in machinery and labor hours. Further, autonomous mowers (and other autonomous work vehicles) may operate precisely to implement the pattern by relying on GPS, known velocity, wheel speed, and precision curvature control to cut or otherwise transform surfaces along straight or curved lines, even over undulating terrain. These advantages may also apply to autonomous work vehicles in other contexts.

In some instances, the combined path may be generated to implement a pattern with a primarily aesthetic purpose which may otherwise be helpful to managers of the operating environment. For example, the sporting public may be more likely to choose to spend time in aesthetically impressive locations than other locations. In another example, patterns with eliminated or minimized defects may serve as superior objects of meditation in certain disciplines (e.g., Zen Buddhism). In other instances, the pattern may have a more practical effect. For example, the implemented pattern may affect the direction of a ball when it strikes a surface or rolls along the pattern. Implementing the pattern with consistency may reduce the amount of random deviation as the ball travels along the surface (e.g., of the green towards the hole of the golf course 600), or may be used to increase the random movement of the ball and the difficulty of navigating the ball along the surface, improving the experience according to the needs of the sporting public.

Thus, the work area may include at least a portion of a golf course 600. The golf course 600 may comprise several distinct work areas. For example, a golf course 600 may comprise a fairway 610, rough 612, and a green 614, each of which are typically cut at different heights and/or whose surface may implement a different pattern. In another example, all areas of the golf course 600, including the fairway 610, rough 612, and green 614, may comprise a single work area which may all implement the same pattern. The pattern may be implemented by cutting the turf of the golf course 600. Implementation of the pattern may be impeded, in part by undulating terrain, but more particularly by obstacles, such as trees 620, bunkers 630, boulders, buildings, or other obstacles.

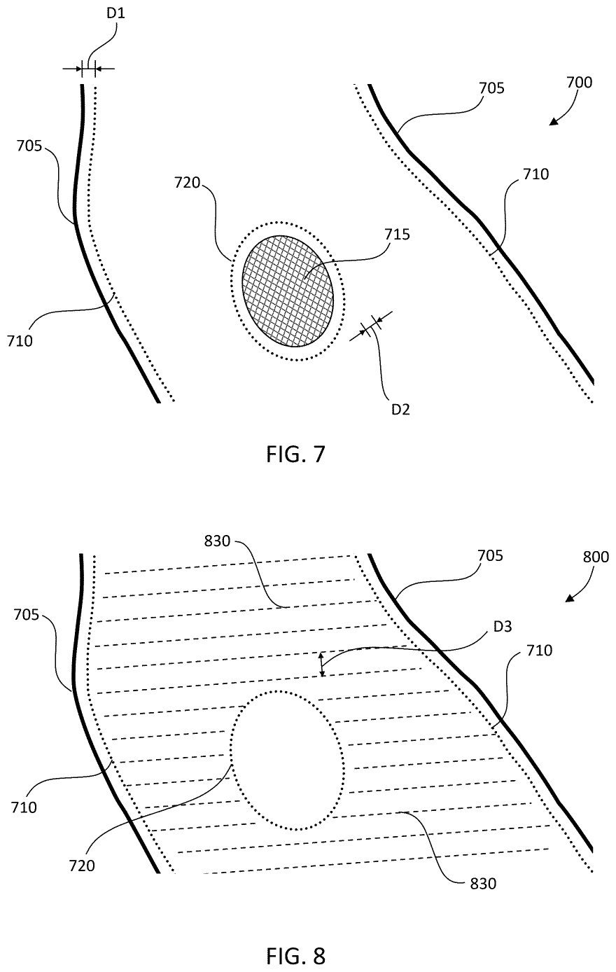

FIG. 7 illustrates a diagram 700 of a portion of a work area, such as a work area of a golf course 600 or other operating environment. The work area may be bounded to the left and right by outer limits 705 (with upper and lower limits not shown). The work area may also comprise one or more interior obstacles 715 (i.e., obstacles disposed within the work area), such as the trees 620, bunker 630, or other obstacle described above. The autonomous mower may follow a combined path, simultaneously cutting the surface of the work area, to implement the pattern.

The combined path may be formed by generating a plurality of paths that trace the work area and then linking or joining the plurality of paths to form the combined path. The plurality of paths may include one or more external paths 710 and internal paths 720 (indicated by circular dotted lines). The external paths 710 may delimit an exterior of the work area, for example, by following or tracing the outer limits 705 of the work area. That is, the external paths 710 may follow a profile of the outer limits 705. In some embodiments, the external paths 710 may surround all or most of the work area. In some embodiments, the external paths 710 may form a loop around the work area. In other embodiments, the plurality of paths may include multiple unconnected external paths 710 that delimit an exterior of the work area.

The external paths 710 may be separated from the outer limit 705 by a distance D1 that is equal to or less than one half of the width of the operating implement (e.g., the mower reel), such that when a center of the operating implement follows the external path the half of the width of the operating implement disposed between the external path 710 and the outer limit 705 cuts or transforms the surface of the work area up to and/or beyond the outer limit 705. In some instances, the distance D1 between the external path 710 and the outer limit 705 may be set such that the operating implement does not cut or transform the surface outside the work area. This may prevent alteration of a desired pattern or appearance of the surface of the work area and/or may prevent harm to the operating implement by preventing collision with obstacles outside the work area. In other embodiments, the distance D1 may be set to allow the operating implement to cut or transform the surface outside the work area. For example, the appearance of the surface outside the work area may not matter to the implementation of the pattern or of the operational task of the autonomous mower. Or the autonomous work vehicle may be limited as to the amount of alteration that the operating implement may make to the surface outside the work area. For example, the surface outside the work area may be or may be planned to be cut at a height less than the height of the work area.

The internal paths 720 may bound one or more interior obstacles 715 of the work area. The internal paths 720 may surround the one or more interior obstacles 715. In some embodiments, one or more internal paths 720 may form a loop. The internal path 720 may form a polygon, such as a quadrilateral (e.g., square, or rectangular shape), a triangular, or other polygonal shape, or a shape that resembles only a part of a polygon. The internal path 720 may form a circular or elliptical shape, or have a shape that resembles only a part of a circle or ellipse.

One or more of the internal paths 720 may trace a profile of the interior obstacle 715. For example, FIG. 7 illustrates an interior obstacle 715 having an elliptical profile, and wherein the internal path 720 follows the elliptical profile of the interior obstacle, such that internal path 720 has an elliptical shape. In another example, the interior obstacle 715 may have a polygonal profile and the internal path 720 may have a polygonal shape that traces the polygonal profile of the interior obstacle 715. The internal path 720 may be separated from an outer limit of the interior obstacle 715 by a second distance D2. The second distance D2 may be set to enable the implement of the autonomous work vehicle to approach the outer limit of the interior obstacle 715. For example, the second distance D2, similar to the first distance D1, may extend to a length of approximately one half the width of the operating implement, such that an autonomous work vehicle traveling along the internal path 720 (with half of the implement extended to either side of the autonomous work vehicle or otherwise traveling such that eh implement extends equal to either side of the internal path 720) alters the surface of the work area close to or meeting the outer limit of the interior obstacle 715.

The interior obstacle 715 may be surrounded by only one internal path 720. Alternatively, the interior obstacle may be surrounded by two or more internal paths 720. In some embodiments, the pattern of the combined path may be based primarily on the internal paths 720, such that the space of the work area between the interior obstacle 715 and the external path 710 is filled with paths that are parallel to or have a same or similar shape as the internal path 720, and/or which are centered about the one or more interior obstacles 715.

FIG. 8 illustrates a diagram 800 of the work area, and illustrates that the plurality of paths may also include a plurality of swath paths 830 (indicated by a dashed line). The swath paths 830 may form the primary portion of the pattern, such that the swath paths 830 may cover at least a majority of the work area between the external paths 710 and/or the internal paths 720. Adjacent swath paths 830 may extend parallel to one another, which may increase the visibility of the pattern. For example, a subset of the swath paths 830, such as a majority or only a minority portion of the swath paths 830, may extend parallel to one another.

As illustrated in FIG. 8, the swath paths 830, such as at least a subset of adjacent swath paths 830 of the plurality of swath paths 830, may each follow a separate straight line along an entire length of the swath path 830. This may enable the pattern to comprise a striped appearance. In other embodiments, the swath paths 830 may not follow a straight line along the entire length of the swath path 830. For example, the swath path 830 may comprise a saw-tooth pattern comprising multiple straight lines joined together at angles to form the swath path. In some embodiments, the swath path 830 may follow a curved line. For example, the swath path 830 may trace an outer limit 705 of the work area.

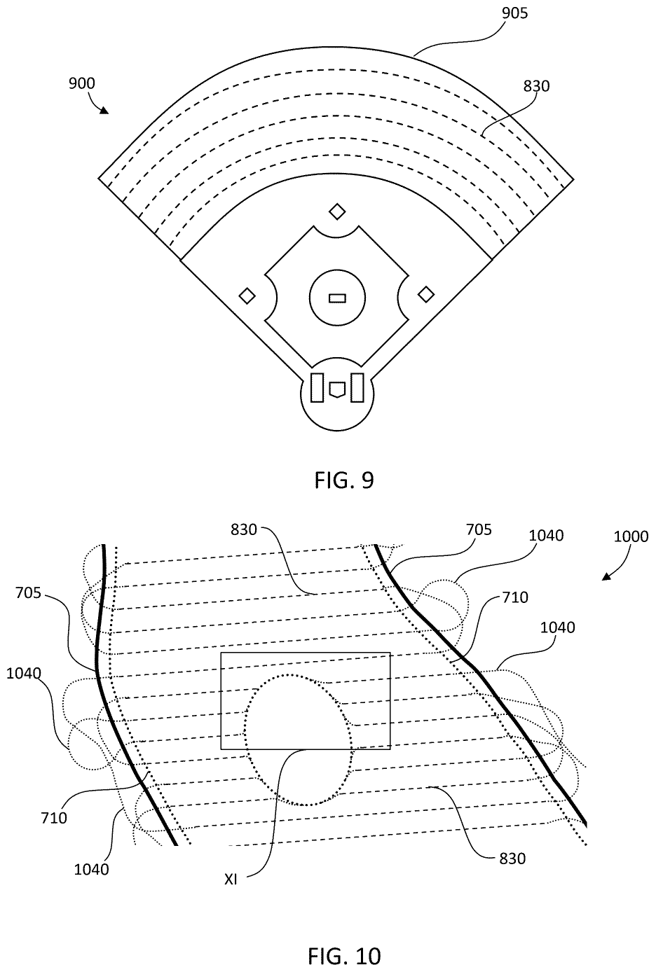

FIG. 9 illustrates a diagram 900 of a work area comprising an outfield of a baseball field. The outfield may be mown by an autonomous mower that cuts the surface when following curved swath paths 830. In the baseball field, the swath paths 830 may trace along the surface in a line parallel or substantially parallel to the outfield wall 905. More specifically, at least a subset of adjacent swath paths 830 of the plurality of swath paths 830 may trace a contour of the external path 710 and the external path may trace a line that extends parallel to the outer limit 705 of the work area.

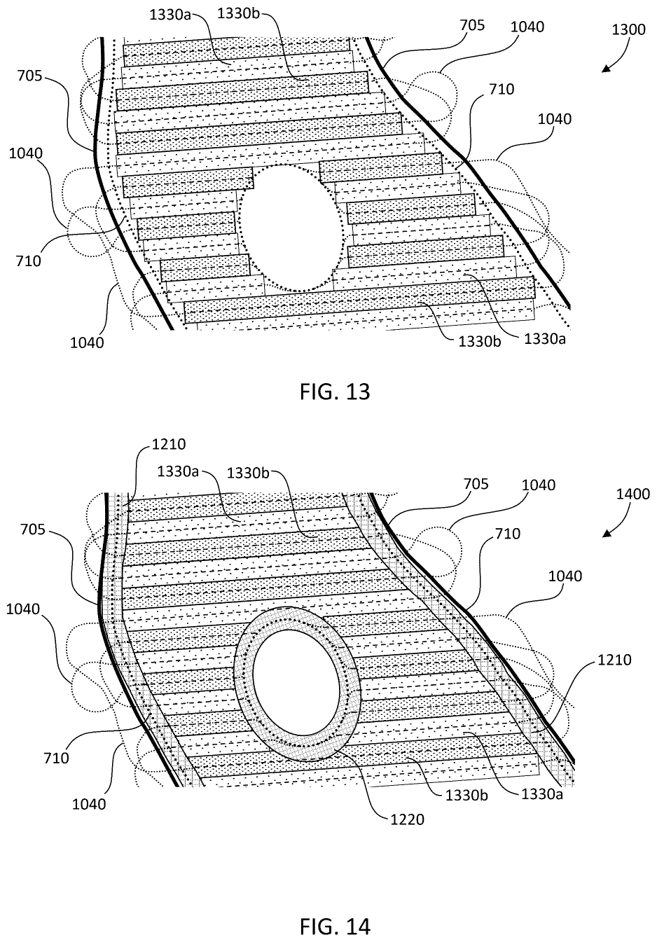

The swath paths 830 may be separated by a distance D3 (see FIG. 8) that is small enough as to not leave the surface uncut between adjacent swath paths 830. Specifically, adjacent swath paths 830 may be separated by a distance equal to or less than a width of an operating implement connected to the autonomous work vehicle, such that a swept area 1330a, 1330b (i.e., the area transformed by the operational implement when following a corresponding path—see FIG. 13) of each of the adjacent swath paths 830 meet and/or overlap.

The swath paths 830 may extend through the work area up to the external paths 710 and/or the internal paths 720, such that no uncut surface is left between the swept area 1210 of the external path 710 and the swept area 1330a, 1330b of the swath path 830. In some embodiments, each end of the swath paths 830 (or of a subset of swath paths 830) that is closest to the external path 710 than to any other path of the plurality of paths is separated from the external path 710 by not more than one half the width of the operating implement.

FIG. 10 shows a diagram 1000 of the work area wherein the plurality of paths may include a plurality of connection paths 1040 (indicated by square dotted lines). The connection paths 1040 may serve to connect the external, internal, and swath paths 710, 720, 830 together and facilitate defining a route the autonomous work vehicle may take to travel along the plurality of paths of the combined path. Each connection path may have a first end and a second end that may extend from a point at or near a first path (e.g., an external, internal, or swath path 710, 720, 830) to a point at or near a second path (e.g., an external, internal, or swath path 710, 720, 830). When any of the connection paths 1040 extends from a swath path 830, they may always extend from an end of the swath path 830. In some embodiments, all or only a subset (e.g., at least one) of the first and second ends of each connection path 1040 may extend to or from an end of a swath path 830, an internal path 720, or external path 710.

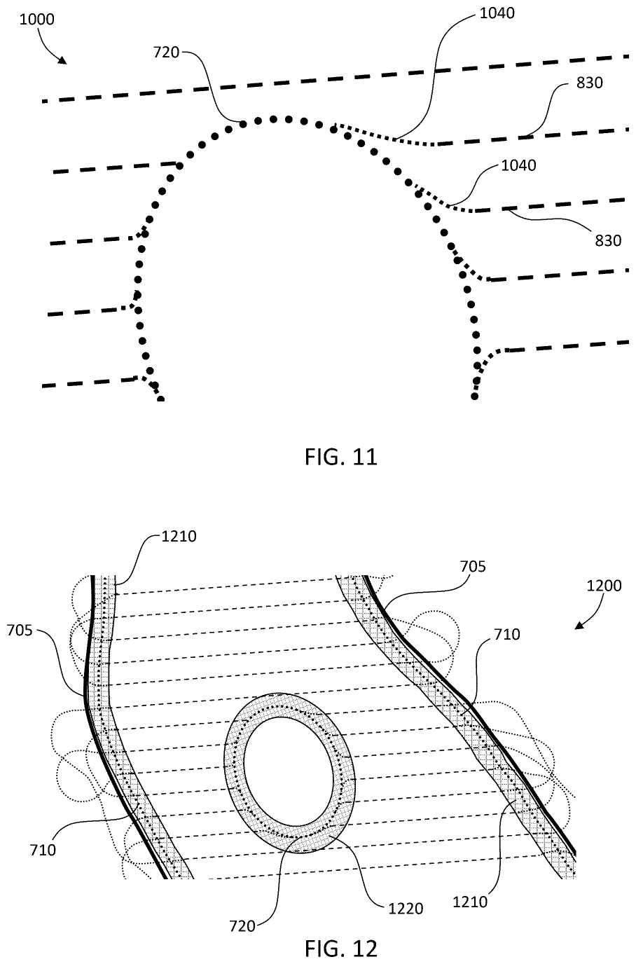

The connection paths 1040 may, as shown in FIG. 10, extend from a first end at or near an end of a swath path 830 to a second end at or near an end of another swath path 830. The first and/or second ends of the connection paths 1040 may extend to the external or internal paths 710, 720. The connection paths 1040 need not extend to an end of the external or internal paths 710, 720, particularly when the external and/or internal paths 710, 720, respectively, comprise a loop. The connection path 1040 may extend from an end of a swath path 830 to a location of the external path 710 or the internal path 720 that is closest to the end of the swath path 830, which enables the autonomous work vehicle to merge onto the external path 710 or internal path 720 smoothly based on a minimum turn radius of the autonomous work vehicle, or is least likely to disturb the pattern implemented on the surface of the work area (e.g., which minimizes traveling of the autonomous work vehicle drive wheels on the work area surface, or which reduces the amount of directional changes of the vehicle wheels). For example, FIG. 11 illustrates a close view of the diagram 1000 within the compartment XI, showing that the connection paths 1040 may curve to gently merge an autonomous work vehicle traveling from the swath paths 830 onto the internal path 720, or vice versa.

In some embodiments, a subset of the connection paths 1040 may extend between an external path 710 and an internal path 720 to enable the autonomous work vehicle to travel between the external path 710 and the internal path 720 without following a swath path 830.

In some embodiments, the connection paths 1040 may extend outside the outer limits 705 of the work area, particularly when an autonomous work vehicle traveling along such a path 1040 is unlikely to disturb a pattern outside the work area or unlikely to harm the autonomous work vehicle and the objects or area outside the work area. Alternatively, the connection paths 1040 may extend within the swept area 1210 (see FIG. 12) of the external paths 710.

The connection paths 1040 may connect the swath paths 830 in a manner that the swept areas 1330a, 1330b (see FIG. 13) of adjacent swath paths 830 are cut when the autonomous work vehicle is traveling in different (e.g., opposite) directions. In this manner, the swept areas 1330a, 1330b of adjacent swath paths 830 may exhibit different cut directions which may enable a viewer to more easily distinguish the pattern of the work area. For example, different cut directions may enable a viewer to more easily see the striped pattern formed by the swath paths 830 of FIGS. 8 and 10. To achieve this, each swath path 830 may only connect (via a connection path 1040) to an adjacent swath path 830 or may only connect to a swath path 830 that is adjacent or separated by an even number (e.g., 2, 4, 6, 8, or 10) of interposed swath paths 830.

The formation of the connection paths 1040 may be based on a minimum turn radius of the autonomous work vehicle. The connection path 1040 may not include a curve that is too tight for the minimum turn radius of the autonomous work vehicle. In some embodiments, the connection path may comprise a turnabout (i.e., a path for a vehicle maneuver, such as a three point turn or other numbered point turn, for reorienting the vehicle) in preparation to follow one of the plurality of paths. A turnabout may be necessary to minimize disturbance of the pattern, particularly when the autonomous work vehicle approaches locations that it cannot safely traverse, such as locations outside the work area or an interior obstacle. In some embodiments, the majority of the turnabout maneuver may be performed in portions covered by the swept area 1210, 1220 of the external and internal paths 710, 720 to minimize disturbance of the pattern.

The combined path may then be generated by linking the one or more external paths 710, the one or more internal paths 720, the plurality of swath paths 830, and the plurality of connection paths 1040. The steering control system and the speed control system may be given instructions for driving the autonomous work vehicle along the combined path through the work area.

FIGS. 12 through 14 show diagrams 1200, 1300, 1400 that illustrate the swept areas 1210, 1220, 1330a, 1330b, of the external, internal, and swath paths 710, 720, 830 to implement the pattern on the surface of the work area. In particular, FIG. 12 illustrates the work area overlaid with a diagram 1200 showing both the swept area 1210 of the external paths 710 and the swept area 1220 of the internal paths 720 (the swept areas 1210, 1220 being indicated with a cross-hatch texture).

FIG. 13 illustrates the work area overlaid with a diagram 1300 showing the swept areas 1330a, 1330b of the swath paths 830. Specifically, diagram 1300 shows first swept areas 1330a (indicated with a low-density dot texture) and second swept areas 1330b (indicated with a high-density dot texture), which may alternate consecutively along a dimension (e.g., length) of the work area. The first swept areas 1330a may be formed as the operating implement transforms the surface of the work area when the autonomous work vehicle is traveling in a first direction, and the second swept areas 1330b may be formed as the operating implement transforms the surface of the work area when the autonomous work vehicle is traveling in a second direction, such as a direction opposite the first direction. This may help to achieve visualization of the pattern.

For example, when forming the first swept area 1330a, a mower reel may cut a surface of the work area when an autonomous mower is traveling towards the right side of the work area, and may when forming the second swept area 1330b, the mower reel may cut a surface of the work area when the autonomous mower is traveling towards the left side of the work area. This may enable the grass of the first and second swept areas 1330a, 1330b to be oriented in different directions, accomplishing and/or enhancing the pattern.

In some embodiments, the swept areas (e.g., swept areas 1330a, 1330b) of the swath paths 830 may differ in other ways. The surface of the work area may be cut to a first height in a first swept area of the swath paths and the may be cut to a second height different from the first height in a second swept area of the swath paths. The swath paths 830, or portions thereof, may be divided into sections, and the height of the surface or dimensions of the pattern motifs may differ from one section to another. For example, the implement may comprise a mower reel of an autonomous mower, the work area may be divided into a first section and a second section, and a height of the mower reel may be adjusted based on the section over which the autonomous mower is operating.

As illustrated by FIG. 13, the autonomous work vehicle may not form swept areas 1330a, 1330b when traveling between the swath paths 830 along the connection paths 1040. This may be achieved by adjusting the operating implement, such as stopping movement of the operating implement or adjusting a position of the operating implement, when the autonomous work vehicle is traveling along the connection paths 1040. Specifically, the implement may be adjusted to a first position (e.g., a lower position in contact with the surface of the work area) when the autonomous work vehicle follows the one or more external paths 710, the one or more internal paths 720, the plurality of swath paths 830, and/or the one or more patch paths 1850 (see below), and the implement may be adjusted to a second position (e.g., a higher position above the surface of the work area) when the autonomous work vehicle follows a connection path 1040 that extends outside the work area, or when the autonomous work vehicle follows any connection path 1040. In some embodiments, the position of the implement may be maintained when traveling along a connection path 1040 between an external path 710, an internal path 720, and/or a swath path 830, within the work area.

FIG. 14 illustrates a diagram 1400 of the work area when swept areas 1210, 1220, 1330a, 1330b of the external, internal, and swath paths 710, 720, 830 are formed. The swept areas 1210, 1220 of the external and internal paths 710, 720 may extend over and hide the ends of the swath paths 830 to clearly define the pattern. After following and traveling along all of the plurality of swath paths 830, the autonomous work vehicle may follow an external path 710, without traveling over the swath paths 830, towards an exit of the work area to mitigate disturbance of the pattern. In some embodiments, the autonomous work vehicle may travel over the swath paths 830 towards the exit of the work area while preventing the operating implement from contacting a surface of the work area. In some embodiments, the swept area 1220 of the internal path 720 may be formed after forming a majority (e.g., all but one, or all but two or three) of the swept areas 1330a, 1330b adjacent to the swept area 1220 of the internal path 720, to enable the autonomous work vehicle to more clearly define the pattern.

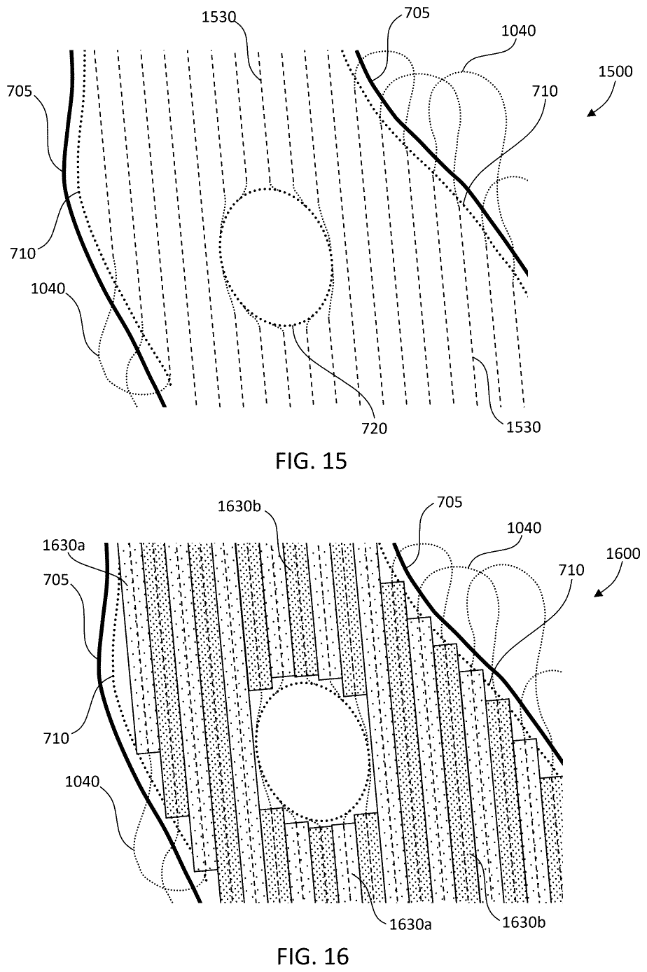

FIGS. 15, 16, and 17 further illustrate diagrams 1500, 1600, 1700 showing that the work area may be traced with additional swath paths 1530. The additional swath paths 1530 may be oriented at an angle relative to the original swath paths 830 to form a more intricate pattern. For example, the additional swath paths 1530 may be oriented perpendicular to the original swath paths 830 to form a checkered pattern on the surface of the work area. The additional swath paths may also be linked (via connection paths 1040) to the external, internal, and original swath paths 710, 720, 830 to form the combined path. The autonomous work vehicle may then follow the additional swath paths 1530 after the original swath paths 830 to form the swept areas 1630a, 1630b, which may have the same or similar characteristics as the first and second swept areas 1330a, 1330b described above.

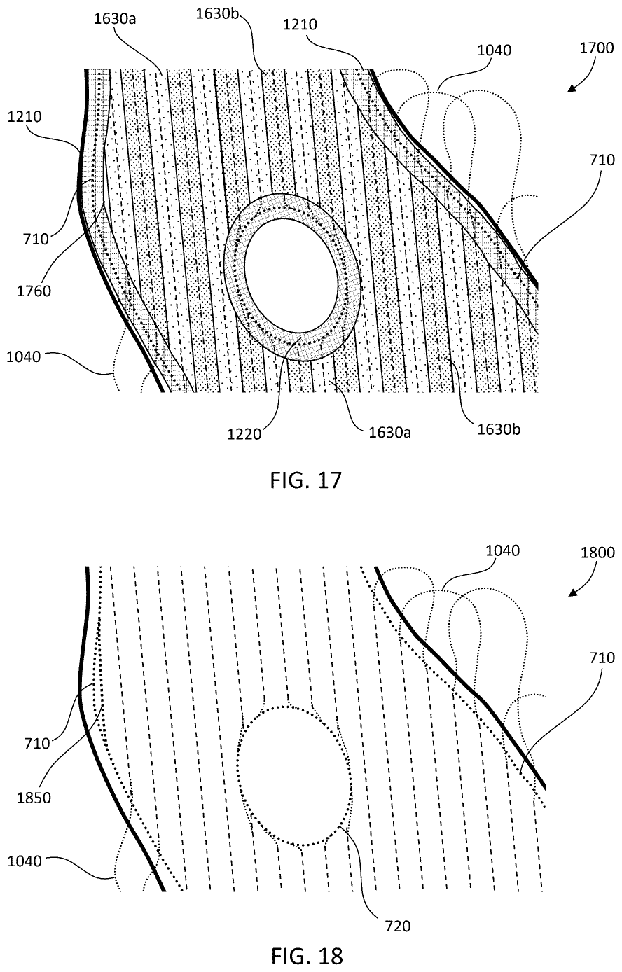

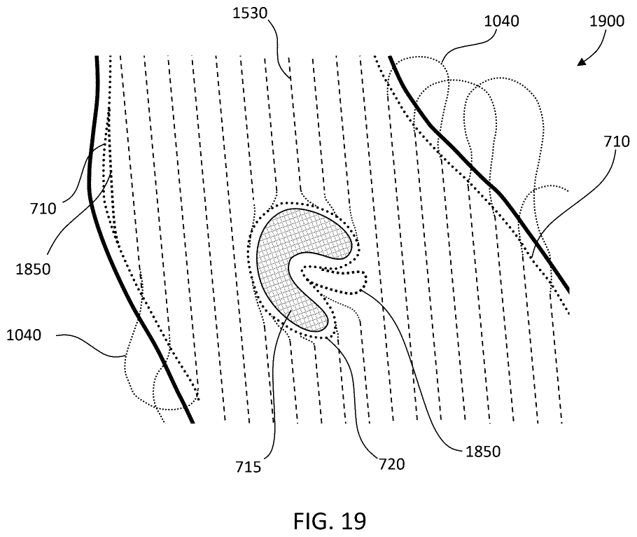

FIG. 17 illustrates a diagram 1700 showing that the work area may comprise untraced areas 1760 that are not covered by the swept areas 1630a, 1630b of the swath paths 1530. Untraced areas may occur within the work area for several reasons, including the inability of the swath paths 1530 to fill the work area, the irregular shapes of interior obstacles (see FIG. 19 below), and/or the limits of the autonomous work vehicle 210 (e.g., the turn radius of the autonomous work vehicle 210 may necessitate turning at precise moments to enable the autonomous work vehicle 210 to merge onto paths of the combined path, which may leave untraced areas behind). FIG. 18 illustrates a diagram 1800 of the work area including a patch path 1850. The patch path 1850 may be generated to extend over the untraced areas 1760 of the work area that remain uncovered despite the swept areas 1210, 1220, 1630a, 1630b. Specifically, generating the combined path (e.g., a final combined path) may comprise determining any remaining untraced areas 1760 of the work area that are not traced by the combined path, creating one or more patch paths 1850 based on the untraced areas 1760, and combining the one or more patch paths 1850 with the combined path. The autonomous work vehicle may then be instructed to follow the combined path, including the external paths 710, internal paths 720, swath paths 830, connection paths 1040, and patch paths 1850, to implement the pattern on the surface of the work area.

The patch path 1850 may be generally parallel to any adjacent swath paths 1530 so as to maintain the pattern of the work area. The patch path 1850 may extend to and/or from any of the plurality of paths, such as an external path 710, an internal path 720, a swath path 830, 1530, or a connection path 1040. However, in some instances, remaining untraced areas 1760 may be more likely to be located near or adjacent to an external path 710 or an internal path 720. In such instances, the patch path 1850 may extend to and/or from an external path 710 and/or an internal path 720.

FIG. 19 illustrates a diagram 1900 where the need for a patch path is likely to arise. The diagram 1900 includes an obstacle 715 that is irregularly shaped. Specifically, the obstacle 715 may be shaped such that interrupted swath paths 1530 are obstructed from covering all of the work area near the obstacle 715. In such instances, a patch path 1850 may be generated and joined to the combined path. FIG. 19 illustrates that the patch path 1850 may extend from and to an interior path 720.

Patch paths 1850 may be joined to the combined path in a manner that enables the autonomous work vehicle 210 to travel along the patch path 1850 immediately before and/or after traveling along adjacent paths. An adjacent path may be any path near to the patch path 1850 that may be reached without crossing an intermediate path, and adjacent paths may include adjacent exterior paths 710, interior paths 720, and swath paths 1530. This may enable the autonomous work vehicle 210 to maintain the pattern implemented on the work area. For example, an autonomous work vehicle 210 that returned to the patch path 1850 after modifying the surface of the adjacent paths with the implement may do so with a risk of disrupting the pattern of the work area (e.g., either by not following exactly adjacent patch paths, or by traveling to the patch path 1850 along a path disruptive to the pattern). In some embodiments, the autonomous work vehicle 210 may follow a patch path 1850 (or, for example, each patch path 1850) before following all adjacent paths. In some embodiments, a patch path 1850 may be followed by the autonomous work vehicle 210 before the autonomous work vehicle 210 follows all swath paths 1530 or a majority of the swath paths 1530.

Alternatively, at least one of the patch paths 1850 may be joined to the combined path in a manner that the autonomous work vehicle 210 travels over an adjacent path. The patch paths 1850 may be connected to the combined path in such a way as to reduce and/or minimize waste, to reduce operating time, and/or to minimize damage to the work area. For example, the patch path 1850 may be connected to the combined path in a manner that reduces or minimizes the complete length of the combined path, which may reduce fuel or energy costs. The patch path 1850 may be connected to the combined path to reduce or minimize the amount of time spent by the autonomous work vehicle 210 driving within the work area. For example, in instances where the autonomous work vehicle 210 must turn around to reach an un-swept portion of the work area, a patch path 1850 forming a loop (e.g., overlapping at least in part with an internal path 720 extending around an obstacle) may be chosen over a patch path 1850 comprising a three-point turn that may require more time to perform. This may particularly be the case when the turn radius of the autonomous work vehicle 210 is large or when stop-and-go maneuvers are time-costly.

The patch paths 1850 may be connected to the combined path such that the autonomous work vehicle 210 avoids traversing sensitive areas within the work area. For example, patch paths 1850 may not extend over wet or muddy areas (wherein traversal by the autonomous work vehicle 210 may enlarge such areas), areas where new turf or other plant material is desired or encouraged to grow, or other areas wherein traversal by the autonomous work vehicle 210 may harm the terrain. The patch path 1850 may extend over pre-formed paths (e.g., walking or driving paths) within the work area to reduce or minimize disruption of the implemented pattern by the autonomous work vehicle 210.

As described above, the method may be performed, at least in part, by a base station 270 in communication with the autonomous work vehicle. For example, the base station 270 may generate the plurality of paths for the autonomous work vehicle, including the one or more external paths 710, the one or more internal paths 720, the plurality of swath paths 830 and the plurality of connection paths 1040. The base station 270 may also generate the combined path by connecting the one or more external paths 710, the one or more internal paths 720, the plurality of swath paths 830, 1530, and the plurality of connection paths 1040 to produce the combined path. The base station 270 may determine any remaining untraced areas 1760 of the work area that are not traced by the combined path, create one or more patch paths 1850 based on the untraced areas 1760, and combine the one or more patch paths 1850 with the combined path. The base station 270 may communicate the combined path to the autonomous work vehicle. The autonomous work vehicle may then receive the combined path and instruct the steering control system and the speed control system to drive the autonomous work vehicle along the combined path through the work area.

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied - for example, blocks can be re-ordered, combined, and/or broken into sub-blocks. Certain blocks or processes can be performed in parallel.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The terms “first”, “second”, “third”, etc. are used to distinguish respective elements and are not used to denote a particular order of those elements unless otherwise specified or order is explicitly described or required.

The conjunction “or” is inclusive.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed:

1. An autonomous work vehicle comprising:
a steering control system for autonomously controlling a driving direction of the autonomous work vehicle;
a speed control system for autonomously controlling a speed of the autonomous work vehicle;
an implement control system for autonomously controlling an implement connected to the autonomous work vehicle, wherein the implement is configured to modify a ground surface of a work area to create a pattern on the work area;
one or more processors communicatively coupled with the steering control system and the speed control system; and
one or more computer-readable media having stored thereon instructions that when executed cause the one or more processors to:
generating a plurality of paths that trace over the work area, including:
one or more external paths that delimit an exterior of the work area;
one or more internal paths that bound one or more interior obstacles of the work area;
a plurality of swath paths that cover at least a majority of the work area between the one or more external paths and/or the one or more internal paths; and
a plurality of connection paths, wherein each connection path of the plurality of connection paths has a first end and a second end, and wherein at least one of the first and second ends of each connection path extends from an external path of the one or more internal paths, an internal path of the one or more internal paths, and/or an end of a swath path of the plurality of swath paths;
generating a combined path by:
connecting the one or more external paths, the one or more internal paths, the plurality of swath paths, and the plurality of connection paths to produce the combined path;
determining any remaining untraced areas of the work area that are not traced by the combined path;
creating one or more patch paths based on the untraced areas; and
combining the one or more patch paths with the combined path; and
instructing the steering control system and the speed control system to drive the autonomous work vehicle along the combined path through the work area.

2. The autonomous work vehicle of claim 1, wherein the connection paths are generated based on a minimum turning radius of the autonomous work vehicle.

3. The autonomous work vehicle of claim 1, wherein the instructions further cause the implement control system to:
adjust the implement to a first position when the autonomous work vehicle follows the one or more external paths, the one or more internal paths, the plurality of swath paths, and/or the one or more patch paths, and
adjust the implement to a second position when the autonomous work vehicle follows a connection path that extends outside the work area.

4. The autonomous work vehicle of claim 1, wherein adjacent swath paths are separated by a distance equal to or less than a width of an operating implement connected to the autonomous work vehicle, such that a swept area of each of the adjacent swath paths meet and/or overlap.

5. The autonomous work vehicle of claim 1, wherein at least a subset of adjacent swath paths of the plurality of swath paths each follow a separate straight line.

6. The autonomous work vehicle of claim 1, wherein at least a subset of adjacent swath paths of the plurality of swath paths traces a contour of the external path of the one or more external paths.

7. The autonomous work vehicle of claim 1, wherein the autonomous work vehicle comprises an autonomous mower.

8. The autonomous work vehicle of claim 7, wherein the work area comprises at least a portion of a golf course.

9. The autonomous work vehicle of claim 7, wherein:
the implement comprises a mower reel;
the work area is divided into a first section and a second section; and
a height of the mower reel is adjusted based on over which section the autonomous mower is operating.

10. The autonomous work vehicle of claim 1, wherein the interior obstacle is surrounded by only one internal path of the one or more internal paths.

11. The autonomous work vehicle of claim 1, wherein the interior obstacle is surrounded by two or more internal paths of the one or more internal paths.

12. The autonomous work vehicle of claim 1, wherein at least one of the one or more internal paths traces a profile of the interior obstacle.

13. The autonomous work vehicle of claim 1, wherein the autonomous work vehicle follows an external path of the one or more external paths after following all of the plurality of swath paths.

14. The autonomous work vehicle of claim 1, wherein the instructions further comprise instructing the steering control system and the speed control system to drive the autonomous work vehicle along a patch path before driving along all adjacent paths.

15. A method for operating an autonomous work vehicle comprising:
generating a plurality of paths that trace over a work area, including:
one or more external paths that delimit an exterior of the work area;
one or more internal paths that bound one or more interior obstacles of the work area;
a plurality of swath paths that cover at least a majority of the work area between the one or more external paths and/or the one or more internal paths; and
a plurality of connection paths, wherein each connection path of the plurality of connection paths has a first end and a second end, and wherein at least one of the first and second ends of each connection path extends from an external path of the one or more external paths, an internal path of the one or more internal paths, and/or an end of a swath path;
generating a combined path by:
connecting the one or more external paths, the one or more internal paths, the plurality of swath paths, and the plurality of connection paths to produce the combined path;
determining any remaining untraced areas of the work area that are not traced by the combined path;
creating one or more patch paths based on the untraced areas; and
combining the one or more patch paths with the combined path; and
instructing a steering control system and a speed control system of an autonomous work vehicle to drive the autonomous work vehicle along the combined path through the work area.

16. The method of claim 15, wherein the connection paths are generated based on a minimum turning radius of the autonomous work vehicle.

17. The method of claim 15, wherein the method further comprises instructing an implement control system of an autonomous work vehicle to:
adjust an implement to a first position when the autonomous work vehicle follows the external path of the one or more external paths, the one or more internal paths, the plurality of swath paths, and/or the one or more patch paths, and
adjust the implement to a second position when the autonomous work vehicle follows a connection path that extends outside the work area.

18. The method of claim 15, further comprising:
dividing the work area into a first section and a second section; and
adjusting a height of an implement connected to an autonomous work vehicle based on over which section the autonomous work vehicle is operating.

19. The method of claim 15, further comprising instructing the autonomous work vehicle to follow an external path of the one or more external paths after following all of the plurality of swath paths.

20. An autonomous work vehicle system for operating an autonomous work vehicle, comprising:
a base station and an autonomous work vehicle;
wherein the base station includes:
one or more processors; and
one or more computer-readable media having stored thereon instructions that when executed cause the one or more processors to:
generate a plurality of paths that trace over a work area, including:
one or more external paths that delimits an exterior of the work area;
one or more internal paths that bound one or more interior obstacles of the work area;
a plurality of swath paths that cover at least a majority of the work area between the one or more external paths and/or the one or more internal paths; and
a plurality of connection paths, wherein each connection path of the plurality of connection paths has a first end and a second end, and wherein at least one of the first and second ends of each connection path extends from an external path of the one or more external paths, an internal path of the one or more internal paths, and/or an end of a swath path;
generate a combined path by:
connecting the one or more external paths, the one or more internal paths, the plurality of swath paths, and the plurality of connection paths to produce the combined path;
determining any remaining untraced areas of the work area that are not traced by the combined path;
creating one or more patch paths based on the untraced areas; and
combining the one or more patch paths with the combined path; and
communicate the combined path to the autonomous work vehicle;
wherein the autonomous work vehicle receives the combined path; and
wherein a steering control system and a speed control system of the autonomous work vehicle drive the autonomous work vehicle along the combined path through the work area.
